(19) United States
(12) Patent Application Publication
(10) Pub. No.: US 2010/0193278 A1
(43) Pub. Date: Aug. 5, 2010

(54) Powered drive apparatus for wheelchair

(76) Inventors: Royce H. Husted, Forest, VA (US); Joel P. Husted, Forest, VA (US)

Correspondence Address: Nicholas A. Camasto, 545 Thatcher, River Forest, IL, 60305, US

(21) Appl. No.: 12/322,589

(22) Filed: Feb. 4, 2009

(51) Int. Cl. B60K 1/00

(52) U.S. Cl. 180/291

(57) ABSTRACT

A power drive apparatus is easily attachable to a conventional wheelchair for converting it into a powered wheelchair. The only change to the conventional wheelchair is the addition of a pair of mounting studs clamped to the front of the wheelchair. The power drive apparatus has an adjustable frame to adapt it to a range of wheelchair configurations and includes a novel mount for the drive motor. A severe-off-road-use version is shown which includes a separate, inboard, non-road-contacting ring for maintaining good driving and braking performance under adverse environmental conditions.

### BACKGROUND OF THE INVENTION AND PRIOR ART

This invention relates generally to wheelchairs and specifically to wheelchairs that are lightweight, manually operable and readably transportable.

Manually operable, i.e., hand propelled, wheelchairs have been manufactured for more than a century without significant change. Generally hand rings are mounted on large drive wheels to assist in propulsion by the user, although very often the actual tires are gripped by the user to propel the wheelchair. Such wheelchairs are generally satisfactory for indoor use over fairly short distances where floors are usually flat and smooth. Outdoor operation on the other hand, on soft ground and up and down hills, presents challenging obstacles for a user of a hand propelled wheelchair. Therefore, some sort of powered wheelchair is very desirable for outdoor use.

Most powered wheelchairs and powered scooters are heavy, complicated, expensive machines. They have small, fat tires and fairly complex joy stick-operated control systems. They generally include two electric motors that may be driven by one or more large lead-acid batteries. While intended for outdoor as well as indoor use, the machines are ill-suited for unpaved surfaces like grass and dirt. Nonetheless, powered wheelchairs and scooters have been a boon to the handicapped and elderly.

Scooters generally have a single motor that drives the wheels through a differential. While the costs and weight of a differential are about the same as an extra motor and gear reduction mechanism, the controls on the scooter are less complicated and the unit is generally more reliable than a two-motor wheelchair. Steering of the front wheel of the scooter is accomplished with a small handlebar. The shopping cart is the most popular type powered scooter and, while designed primarily for indoor use, it also sees limited outdoor service in transporting both the user and groceries across the store parking lot. These vehicles' major drawbacks of cost, bulk and weight (generally in the range of 150 to 200 pounds), have prevented their widespread acceptance despite their obvious advantages. They also require special measures in order to transport them. A serious drawback is that the motor drives the wheels through gearing which cannot be overdriven. Thus a drive failure, or a dead battery, can leave the 200 pound vehicle frozen in place with its wheels effectively locked and the user helplessly stranded.

Generally a special type van, or other vehicle providing a large door opening and specialized access equipment, is required to transport powered wheelchairs and powered scooters. The expensive vehicle is usually equipped with a power lift of some sort to enable loading and unloading of such a wheelchair.

The present invention is specifically directed to wheelchairs that are lightweight, compact and maneuverable and which are designed to have great appeal to persons of limited disability who wish to project a more able and athletic persona. Such wheelchairs are available in very light weight materials such as titanium and often have carbon fiber wheels and customized paint schemes to reflect a more active lifestyle. Despite the light weight and maneuverability of these manual wheelchairs, powered wheelchairs are far more capable of handling hills, grass and off road conditions. Thus, Applicants' perceived a need for some means to enable light weight wheelchairs to be motorized, preferably without detracting from the appearance, maneuverability and transportability of the wheelchair.

Applicant's U.S. Pat. No. 6,273,212, issued Aug. 14, 2001 describes a lightweight maneuverable power chair that uses a drive system that is similar to that of the present invention. The power chair of the patent is especially suitable for longer distances and outdoor use over difficult terrain, and may be readily transported without the need for special equipment.

Applicants' U.S. Pat. No. 6,371,228, issued Apr. 16, 2002 describes a stable, low speed powered tricycle with a traction steering drive system similar to that of the present invention. A version of the tricycle that has many recreational uses is also disclosed in the patent.

As mentioned above, the power chair of the invention is readily transportable in the trunk of a compact automobile and is easily hand propelled, when indoors, because of its lack of bulk and extreme light weight. It has in addition, excellent maneuverability and its drive wheels are normally free wheeling. Propulsion and steering are provided by selectively engaging the drive wheels with friction drive rollers that are affixed to the axle of a DC motor. The engagement between the friction rollers and the drive wheels is controlled by a pair of rocker levers that are simultaneously pushed forward for forward propulsion and pulled backward for braking. Normal turning is accomplished by engaging only one of the friction rollers with the desired drive wheel. Very tight turns may be made by simultaneously engaging the friction roller corresponding to the desired drive wheel and the opposite brake surface with the other drive wheel.

### OBJECTS OF THE INVENTION

A principal object of the invention is to provide a novel wheelchair.

Another object of the invention is to provide a novel powered wheelchair that is lightweight, maneuverable and easily transportable.

A feature of the invention resides in the arrangement for rapidly converting a manual wheelchair into a powered wheelchair.

Another feature of the invention resides in a motor mount that permits limited rotational, pivotal and translational movements.

A still further feature of the invention resides in the adjustable frame for enabling the invention to be adapted to a range of wheelchair dimensions.

Still another feature of the invention resides in a special tire and drive arrangement for enabling heavier off road use.

### BRIEF DESCRIPTION OF THE DRAWINGS

These and other objects and features of the invention will be apparent upon reading the following description in conjunction with the drawings in which:

FIG. 1 shows a prior art lightweight wheelchair;

FIG. 2 is a side view of the inventive power drive apparatus;

FIG. 3 is a side view of the prior art wheelchair of FIG. 1 with the invention of FIG. 2 installed;

FIGS. 3A and 3B illustrate clamps used with the invention;

FIG. 4 is a front view of the wheelchair of FIG. 3 with a portion of the left side cut away;

FIG. 5 is a front view of the power drive apparatus of the invention;

FIG. 6 is a top view of the power drive apparatus of the invention;

FIG. 7 is an enlarged partial view taken along the line 7-7 of FIG. 5 showing the novel motor suspension system of the invention; and

FIGS. 8 and 9 illustrate the invention for use with a wheelchair having knobby tires for more rugged off-road use.

### SUMMARY OF THE INVENTION

The invention comprises a power drive apparatus that may be quickly and easily installed on a manually operable wheelchair to convert it into a motorized wheelchair. It includes a battery; a motor and control system; brake surfaces or pads; friction drive rollers connected to the motor; and user operated rocker levers, for selectively engaging the drive rollers and/or brake surfaces with the wheelchair drive wheels for propelling, turning and braking the wheelchair. The power drive apparatus frame is adjustable to adapt to a range of wheelchair dimensions.

### DESCRIPTION OF THE PREFERRED EMBODIMENT

FIG. 1 illustrates a prior art lightweight, wheelchair 10 having a frame 12 supporting a seat 14 and includes a pair of free wheeling drive wheels 16 and a pair of front caster wheels 18. The drive wheels are equipped with rubber tires, and smaller hand rings, to facilitate user propulsion. Since these lightweight wheelchairs are designed for portability, they generally include mechanisms that permit rapid removal and replacement of the drive wheels to facilitate storage in automobile trunks and the like. It will be appreciated that such wheelchairs are well known in the art and form no part of the present invention.

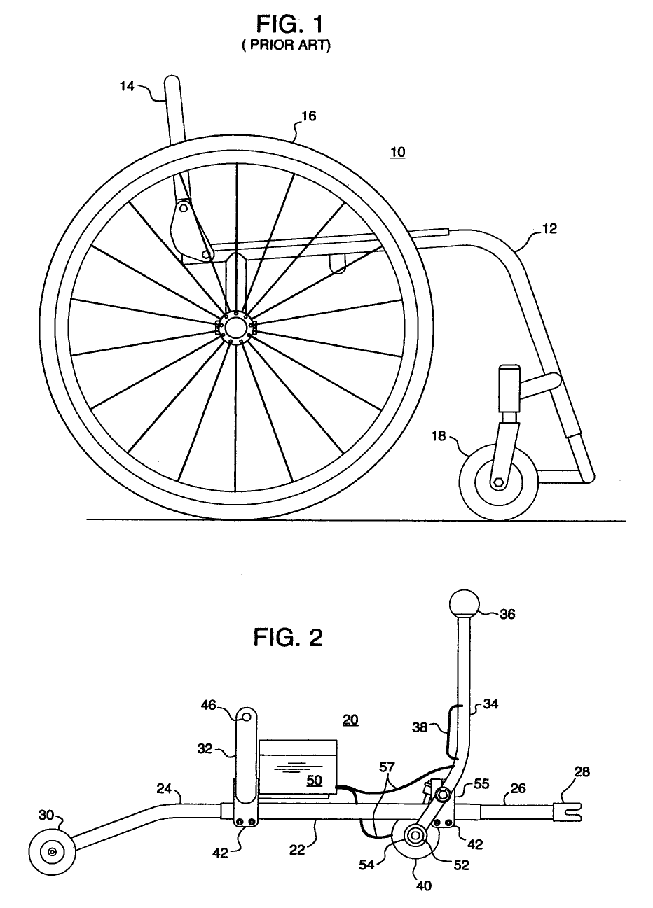

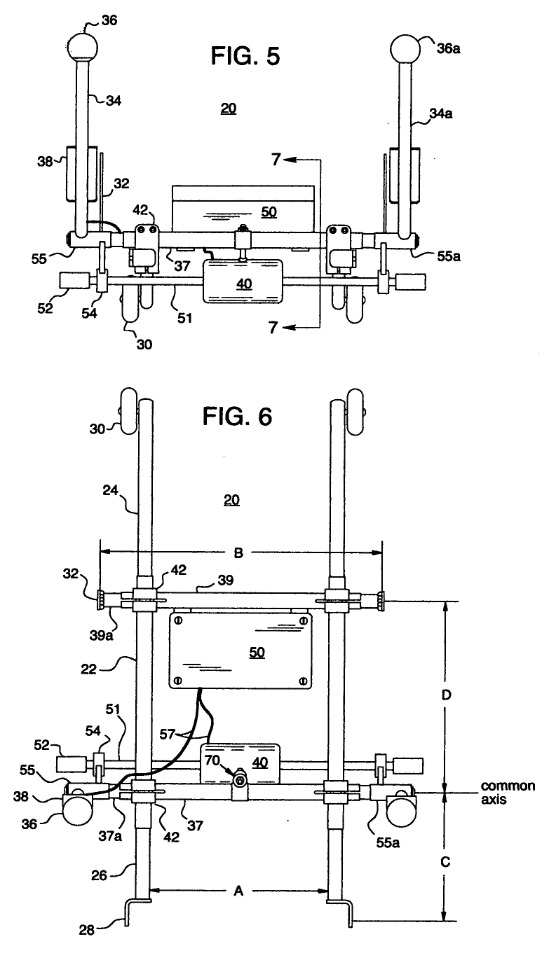

FIG. 2 is a side view of the power drive apparatus 20 of the invention which is adapted to be rapidly secured to (and removed from) the wheelchair of FIG. 1. The wheelchair and the power drive apparatus generally have left and right side symmetry; for simplicity therefore, the discussion will reference the right sides. As most clearly shown in FIGS. 5 and 6, power drive apparatus 20 comprises a generally H-shaped frame formed by a pair of parallel tubular side members, each consisting of a center section 22, a telescoping rear section 24 and a telescoping front section 26, joined by cross members 37 and 39 having telescoping end pieces 37a and 39a, respectively. It should be noted that cross member 37 defines a common axis for the power drive apparatus. Front section 26 terminates in a slotted end bracket 28 and rear section 24 is fitted with an anti tip wheel 30. The ends of center sections 22 and cross members 37 and 39 are split and, in cooperation with four double-tube clamping blocks 42, enable the distances A, B, C and D to be changed to adjust power drive apparatus 20 to wheelchairs of slightly differing dimensions. The double-tube clamping blocks secure tubular members crossing at right angles and enable movement of the telescoping members to adjust the frame. Once the power drive apparatus is set up for a particular wheelchair, its configuration is secured by tightening bolts in clamping blocks 42.

A rocker lever 34 has a twist grip 36, which houses a throttling device or other well-known adjustment device (not shown) at one end, terminates in a rotatable sleeve 55. (It will be appreciated that a similar rocker lever 34a, with a grip 36a, on the opposite side of the frame also terminates in a rotatable sleeve 55a and that both rotatable sleeves are on the common axis. However, grip 36a does not rotate and does not contain a throttling device.) A bearing bracket 54 extends downwardly from sleeve 55 and supports one end of an axle 51 of a DC motor 40. A resiliently mounted ball bearing, not shown, is secured in the end of bearing bracket 54, the resilient mounting permitting limited movement of the ball bearing to accommodate angular variations of the motor axle 51 responsive to rocker lever movement. A drive roller 52 is secured to the end of axle 51 and a brake pad 38 is welded to rocker lever 34. A power system box 50 is secured to cross member 39 and includes a battery and a suitable electronic speed controller (neither shown) for supplying a variable DC voltage to motor 40, via wiring 57, responsive to rotation of twist grip 36. A bracket 32, as will be seen, includes a hole 46 for suspending power drive apparatus 20 from the axle-supporting support structure 33 of the wheelchair.

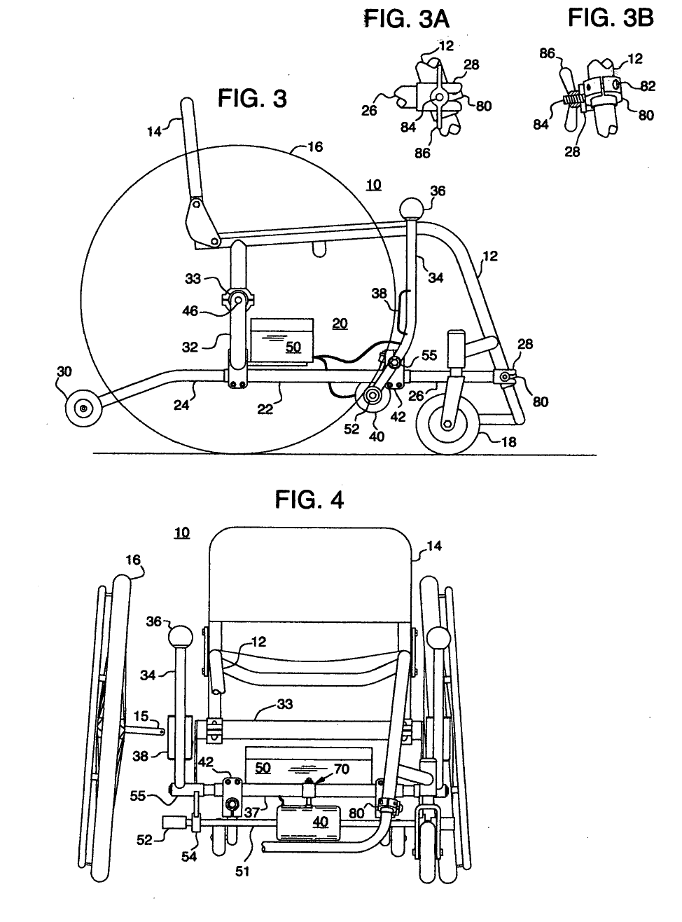

FIGS. 3 and 4, respectively, show the side and front views of wheelchair 10 fitted with power drive apparatus 20. The only additions required for wheelchair 10 are front clamps 80 to which the slotted end brackets 28 are secured. As shown in FIGS. 3A and 3B, front clamp 80 comprises a split collar, secured via bolts 82 to frame 12, which supports a stud 84 for securing end bracket 28 thereto via a large wing nut 86, or other suitable attachment device.

Drive roller 52 and brake pad 38 are normally positioned close to, but out of contact with, the periphery of drive wheel 16. Thus, with no force applied to twist grip 36 (and its corresponding grip on the other side of the wheelchair) the wheelchair is “free wheeling” and may be operated manually. Pushing forward on twist grip 36 rotates sleeve 55 to engage drive roller 52 with wheel 16, whereas pulling backward on twist grip 36 engages brake pad 38 with wheel 16.

In FIG. 4 motor 40 is seen to be supported from cross tube 37 by a special mount 70 that is described in detail below. As mentioned above, the sleeves 55, with bearing brackets 54, are journaled for independent rotational movement on opposite ends of cross tube 37 about the common axis. In this manner sleeves 55 are independently movable by the rocker levers to cause selective engagement between the drive rollers, brake pads and drive wheels. As shown, drive wheel 16 has a short axle 15 that fits within support structure 33. As mentioned above, drive wheel 16 is preferably secured to the wheelchair by a quick release mechanism.

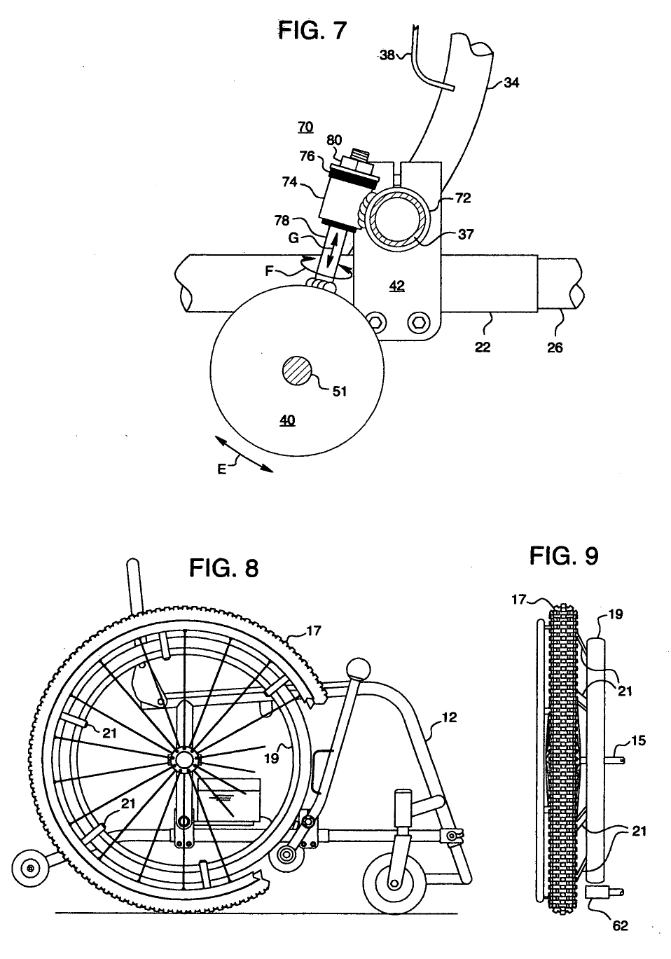

In FIG. 7 a sleeve bushing 72 is rotatably mounted on cross tube 37. A collar 74 is welded to sleeve bushing 72 and supports a bushing 76 therein. Bushing 76 may be made of rubber, although that is not required. A stud 78 is welded to motor 40, extends through bushing 76 and has a nut and washer 80 secured to its threaded end. The arrangement enables the weight of motor 40 to be supported by collar 74 while being capable of; rotational movement about sleeve bushing 72; rotational movement within collar 74; and translational movement within collar 74. These movements are indicated by the arrows E, F and G which result from user operation of the rocker levers for propelling, steering and braking of the wheelchair. It will be noted that for forward movement or braking, the rocker levers rotate about the common axis and there is no tendency for translational movement (arrow G) of the motor in the collar. For opposed rocker lever movements, the motor is moved in the direction of arrow G.

FIGS. 8 and 9 depict a modified wheel for use with the invention in conditions where water, mud, road debris and the like are expected to be encountered. The modified wheel includes a large, knobby tire 17 for greater traction under such conditions and a smaller diameter inboard-mounted ring 19 having a friction surface for engagement with the drive roller and brake pad. The knobby tire, while excellent for enhanced traction, does not mate as well with the drive roller and brake surface of the power drive apparatus. The added inboard ring, on the other hand, being of smaller diameter than the knobby tire, remains relatively free of water, mud and road debris and continues to interface well with the drive roller and brake surface. Ring 19 is secured to the wheel by means of a plurality of brackets 21. It will be appreciated that the frame of the power drive apparatus will be adjusted to conform to the new dimensions imposed by the added inboard ring 19.

What has been described is a novel power drive apparatus for attachment to a conventional wheelchair to convert it into a powered wheelchair. The power drive apparatus has an adjustable frame to adapt it to a range of wheelchair configurations and includes a novel suspension system for the drive motor.

1. A power drive apparatus for a wheelchair having a pair of free wheeling drive wheels, said power drive apparatus comprising:
a frame adapted for removable attachment to, and support from, said wheelchair;
said frame defining a common axis;
a pair of rocker levers mounted for pivotal movement about said common axis;
a motor mount on said frame supporting said motor for limited rotational, pivotal and translational movements;
a pair of drive rollers supported by said rocker levers and coupled to opposite ends of said motor;
a pair of brake surfaces supported by said rocker levers;
said drive rollers and said brake surfaces being normally disengaged from said drive wheels; and
a pair of control handles coupled to said rocker levers for controlling engagement of said drive rollers and said brake surfaces with said drive wheels for enabling forward propulsion, braking and steering of said wheelchair.

2. The apparatus of claim 1 wherein said frame is adjustable to accommodate a range of wheelchair dimensions.

3. The apparatus of claim 2, wherein said frame comprises;
a generally H-shaped arrangement of telescoping tubular members; and
a plurality of adjustable clamping members for securing said members in desired positions.

4. The apparatus of claim 1, wherein said wheelchair includes a support structure for rotationally supporting said drive wheels and wherein said frame includes bracket members for suspending said frame from said support structure.

5. The apparatus of claim 4, wherein said drive wheels include quick release axles supported in said support structure, and wherein said bracket members include apertures for engaging said axles.

6. The apparatus of claim 4 wherein said drive wheels of said wheelchair include inboard mounted non-ground-contacting rings having outwardly facing friction surfaces for engagement by said drive rollers and said brake surfaces.

7. The apparatus of claim 5, wherein said drive wheels include quick release axles supported in said support structure, and wherein said bracket members include apertures for engaging said axles.

8. The apparatus of claim 1, wherein said motor mount further includes:
a bushing rotatable about said common axis;
a collar secured to said bushing; and
a post secured to said motor and freely suspending said motor from said collar.

9. The apparatus of claim 1, wherein said frame includes a pair of rearwardly extending anti tip wheels.

10. A power drive apparatus for a wheelchair having a pair of free wheeling drive wheels, said power drive apparatus comprising:
an adjustable frame adapted for removable attachment to, and support from, said wheelchair;
said frame defining a common axis;
a pair of rocker levers mounted for pivotal movement about said common axis;
a motor mount on said frame supporting said motor for limited rotational, pivotal and translational movements;
a pair of drive rollers supported by said rocker levers and coupled to opposite ends of said motor;
a pair of brake surfaces supported by said rocker levers;
said drive rollers and said brake surfaces being normally disengaged from said drive wheels;
a pair of control handles coupled to said rocker levers for controlling engagement of said drive rollers and said brake surfaces with said drive wheels for enabling forward propulsion, braking and steering of said wheelchair; and
said adjustable frame including a generally H-shaped arrangement of telescoping tubular members and a plurality of adjustable clamping members for securing said members in desired positions.

11. The apparatus of claim 10, wherein said wheelchair includes a support structure for rotationally supporting said drive wheels and wherein said frame includes bracket members for suspending said frame from said support structure.

12. The apparatus of claim 10, wherein said wheels include quick release axles supported in said support structure, and wherein said bracket members include apertures for engaging said axles.

13. The apparatus of claim 10, wherein said motor mount further includes:
a bushing rotatable about said common axis;
a collar secured to said bushing; and
a post secured to said motor and freely suspending said motor from said collar.

14. The apparatus of claim 10, wherein said frame includes a pair of rearwardly extending anti tip wheels.
